(19) United States
(12) Patent Application Publication
(10) Pub. No.: US 2019/0369780 A1
(43) Pub. Date: Dec. 5, 2019

(54) METHOD FOR REDUCING LOCAL IMPEDANCE OF A TRANSPARENT CONDUCTIVE FILM AND PRODUCT THEREOF

(71) Applicants: Chih-Chiang Pai, Taoyuan (TW); Meng-Guei Lin, Taoyuan (TW); Chin-Fong Lin, Taoyuan (TW); Chiu-Wen Chen, Taoyuan (TW)

(72) Inventors: Chih-Chiang Pai, Taoyuan (TW); Meng-Guei Lin, Taoyuan (TW); Chin-Fong Lin, Taoyuan (TW); Chiu-Wen Chen, Taoyuan (TW)

(73) Assignee: Young Fast Optoelectronics Co., Ltd., Taoyuan (TW)

(21) Appl. No.: 15/993,651

(22) Filed: May 31, 2018

(51) Int. Cl. G06F 3/047; H01B 5/12; H01B 1/08; H01B 1/02; G06F 3/044

(52) U.S. Cl. CPC G06F 3/047; H01B 5/12; G06F 2203/04112; H01B 1/023; G06F 3/044; H01B 1/08

(57) ABSTRACT

A method for improving electric characteristic of a touch panel is disclosed. The method includes the steps of: a) providing a transparent conductive layer; b) defining a local area on the transparent conductive layer; and c) laying down a conductive unit. The transparent conductive layer is made of metal oxide. The conductive unit is metal wires. A width of each of the metal wires is less than 5 μm.

### BACKGROUND OF THE INVENTION

### 1. Technical Field

The invention relates to touch panels, particularly to a method for reducing local impedance of a transparent conductive film and product thereof.

### 2. Related Art

Metal oxide such as indium tin oxide (ITO) is frequently used to be a material of transparent conductive films applied in various transparent touch panels because of its transmittance and conductivity. However, transmittance of ITO is inversely proportional to conductivity thereof. That is, the higher the transmittance is, the lower the conductivity is. For example, when surface resistivity of a film is below 10 Ω/sq, transmittance of visible light of the film can reach 80%, if transmittance is wanted to reach 90%, surface resistivity will be over 100 Ω/sq. As a result, conventional ITO transparent conductive films suffer in double limitations of transmittance and conductivity.

Most touch sensors are made of transparent indium tin oxide (ITO) films, on which touch sensing electrodes and their signal paths are formed. However, recent electronic products tend toward compactness and precision, so touch sensing electrodes and signal paths become tinier and tinier in size. Narrowed ITO sensing electrodes and signal paths will increase impedance to attenuate signals. It is adverse to signal transmission. Accordingly, a serious problem to large-sized touch panels is hard to be overcome.

### SUMMARY OF THE INVENTION

An object of the invention is to provide a method for reducing local impedance of a transparent conductive film, which can reduce impedance of local area of a transparent conductive film without reducing visibility to improve transmission efficiency. This can expand an available range of transparent conductive films applied in touch sensors.

To accomplish the above object, the method for reducing local impedance of a transparent conductive film of the invention includes the steps of: a) providing a transparent conductive layer; b) defining a local area on the transparent conductive layer; and c) laying down a conductive unit. The transparent conductive layer is made of metal oxide or graphene. The metal oxide is indium tin oxide, indium zinc oxide, aluminum zinc oxide, antimony tin oxide or poly(3,4-ethylenedioxythiophene). The local area comprises touch sensing electrodes or touch signal transmission lines. Electrical resistivity of the conductive elements is below 8×10⁻⁸ Ω·m. The conductive unit is metal wires or metal mesh. The metal wires are made of gold, silver, copper, aluminum, molybdenum, nickel or an alloy thereof. A width of each of the metal wires is less than 5 μm. The each of the metal wires is a continuously straight or waved line. Each of the metal wires is a broken line.

Another object of the invention is to provide a transparent conductive film with low local impedance, which can decrease thickness of a transparent conductive film to increase transmittance and save material cost. Also, this can increase conductivity and signal transmission efficiency of a local area to be advantageous to design of large-sized touch panels and can expand an available range of transparent conductive films applied in touch sensors.

To accomplish the above object, the transparent conductive film of the invention includes a transparent conductive layer having a pre-determined local area, and a conductive unit laid down in the local area. The transparent conductive layer is made of metal oxide or graphene. The metal oxide is indium tin oxide, indium zinc oxide, aluminum zinc oxide, antimony tin oxide or poly(3,4-ethylenedioxythiophene). The local area comprises touch sensing electrodes or touch signal transmission lines. Electrical resistivity of the conductive elements is below 8×10⁻⁸ Ω·m. The conductive unit is metal wires or metal mesh. The metal wires are made of gold, silver, copper, aluminum, molybdenum, nickel or an alloy thereof. A width of each of the metal wires is less than 5 μm. The each of the metal wires is a continuously straight or waved line. Each of the metal wires is a broken line.

### BRIEF DESCRIPTION OF THE DRAWINGS

FIG. 1 is a schematic view of a laminated structure of the touch sensor of the invention;

FIG. 2 is a top view of the touch sensor of the invention;

FIG. 3 is a bottom view of the touch sensor of the invention;

FIG. 4 is a plan view of the X-axis sensing layer of the touch sensor of the invention;

FIG. 5 is a plan view of the Y-axis sensing layer of the touch sensor of the invention;

FIG. 6 is a plan view of another Y-axis sensing layer of the touch sensor of the invention, which shows waved wires connected to the sensing strings;

FIG. 7 is a plan view of still another sensing layer of the touch sensor of the invention, which shows broken wires connected to the sensing strings

FIG. 8 is a plan view of yet another sensing layer of the touch sensor of the invention, which shows parallelly arranged wires connected to the sensing strings;

FIG. 9 is a flowchart of the method of the invention; and

FIGS. 10 and 11 are two schematic views of two transparent conductive films made by the method of the invention.

### DETAILED DESCRIPTION OF THE INVENTION

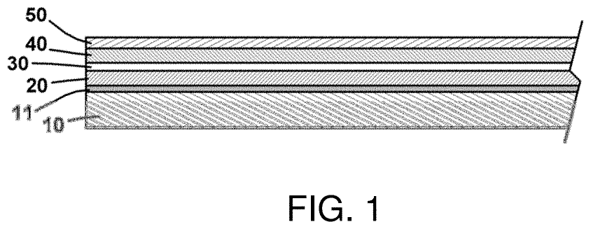

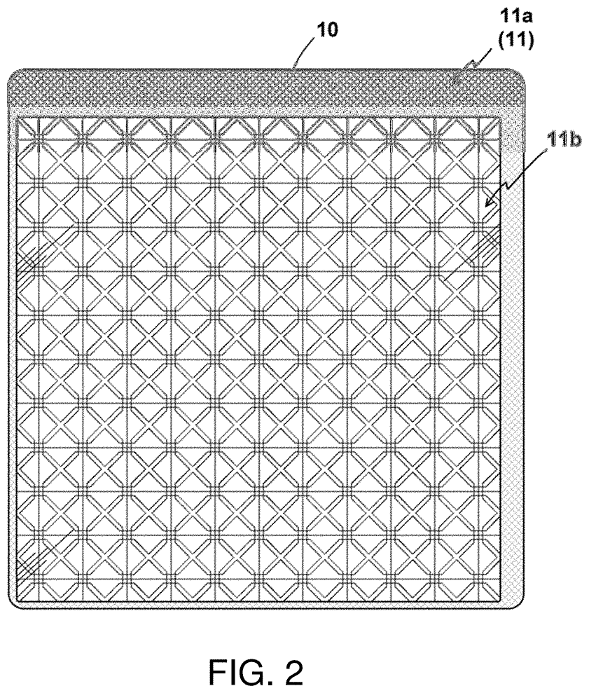

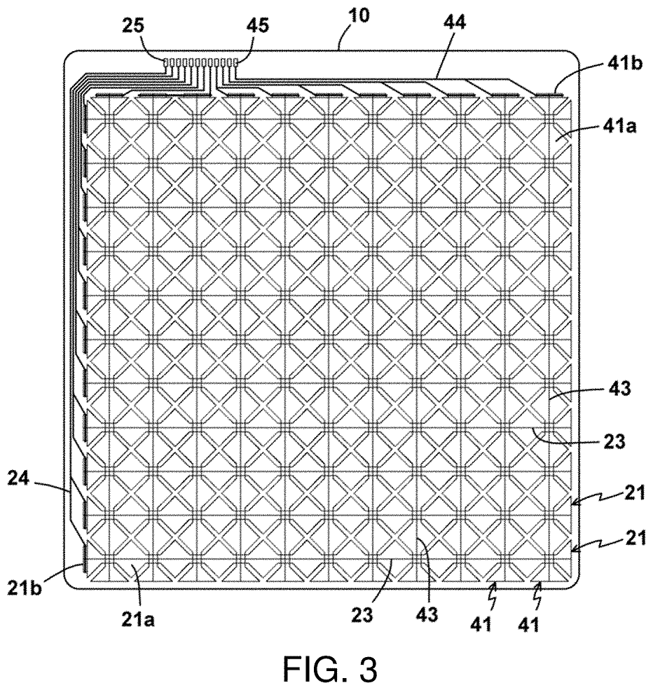

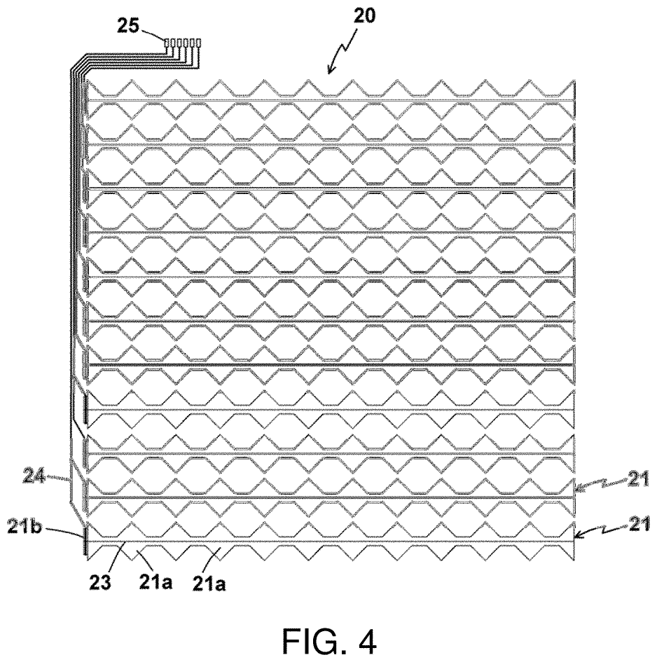

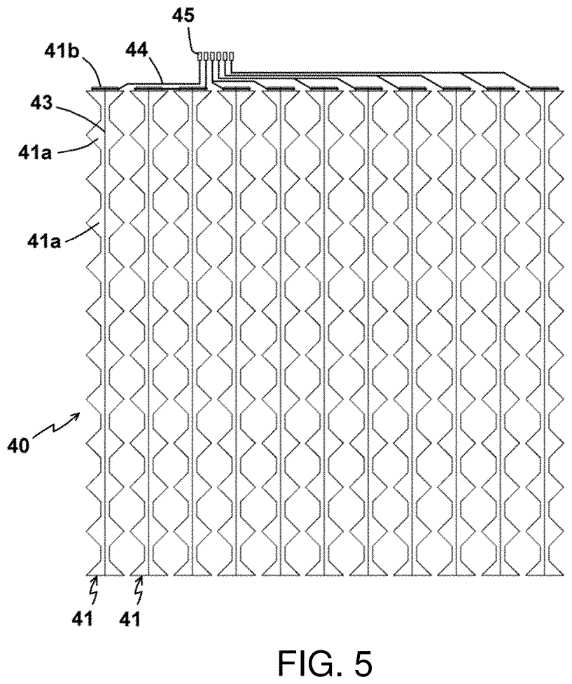

FIGS. 1-5 show an embodiment of the transparent conductive film with low local impedance of the invention applied in a transparent touch sensor structure, which mainly connects a touch sensing string with a conductive unit (i.e., hereinafter called “metal wires”) with high conductivity.

The transparent capacitive touch panel structure includes a base layer 10, an X-axis sensing layer 20, an insulative layer 30, a Y-axis sensing layer 40 and a cover layer 50. The base layer 10 is a glass thin plate with great mechanical strength and high transmittance. A periphery of the base layer 10 is provided with a colored bezel 11 formed by an insulative black matrix (BM) material. The colored bezel 11 defines a shaded area 11a on the base layer 10 and a visible area 11b within the shaded area 11a.

The X-axis sensing layer 20 is disposed in the visible area 11b and includes multiple rows of X-axis sensing strings 21. Each X-axis sensing string 21 is composed of rhombic first sensing units 21a connected in series along an X-axis direction. An end of each X-axis sensing string 21 is provided with a first contact 21b. Each X-axis sensing string 21 has a first metal wire 23 along the X-axis direction. Each first metal wire 23 electrically connects to one of the first contacts 21b and a string of the first sensing units 21a. Each first contact 21b is connected to a first signal output contact 25 through a first signal wire 24. The first signal wires 24 are located in the shaded area 11a along an edge of the base layer 10. Two ends of each first signal wire 24 are separately connected to one of the first contacts 21b and the first signal output contacts 25.

The Y-axis sensing layer 40 is disposed in the visible area 11b and includes multiple rows of Y-axis sensing strings 41. Each Y-axis sensing string 41 is composed of rhombic second sensing units 41a connected in series along a Y-axis direction. An end of each Y-axis sensing string 41 is provided with a second contact 41b. Each Y-axis sensing string 41 has a second metal wire 43 along the Y-axis direction. Each second metal wire 43 electrically connects to one of the second contacts 41b and a string of the second sensing units 41a. Each second contact 41b is connected to a second signal output contact 45 through a second signal wire 44. The second signal wires 44 are located in the shaded area 11a along an edge of the base layer 10. Two ends of each second signal wire 44 are separately connected to one of the second contacts 41b and the second signal output contacts 45.

The signal output contacts 25, 45 can be used for connecting a signal cable (not shown) to send touch signals to a processor (not shown).

The X-axis and Y-axis sensing layers 20, 40 are made of transparent conductive films made of metal oxide such as indium tin oxide (ITO). The first and second metal wires 23, 43 adopt a material with low resistance, electrical resistivity of each of the metal wires 23, 43 is below 8×10⁻⁸ Ω·m, such as copper. Because the first and second metal wires 23, 43 possess a lower impedance than those of the X-axis and Y-axis sensing layers 20, 40, connecting the first and second metal wires 23, 43 to the X-axis and Y-axis sensing strings 21, 41 can enhance transmission effect of touch signals and effectively reduce an impedance between the first sensing units 21a in a string and the first contact 21b connected thereto and between the second sensing units 41a in a string and the second contact 41b connected thereto to reduce attenuation in transmission of touch signals. It is noted that each of the first and second metal wires 23, 43 is set to be below 5 μm in width. Such a nanoscale metal wire is still invisible by the naked eye even if it is made of an opaque material, so it is suitable to be used in the visible area 11 without reducing visibility of the transparent touch sensor.

The X-axis and Y-axis sensing layers 20, 40 are insulatively separated by the transparent insulative layer 30 and the first and second sensing units 21a, 41a separately on the two sensing layers 20, 40 are arranged correspondingly complementarily to form a rhombic grid shaped sensing matrix. The transparent insulative layer 30 may be made of optical clear adhesive (OCA) or optical clear resin (OCR) to paste the two layers 20, 40.

Additionally, the cover layer 50 is adhered on the Y-axis sensing layer 40 for protection. The cover layer 50 is an insulative film with high transmittance, such as polyethylene terephthalate (PET), Cyclo-olefin polymer (COP), poly(ethylene naphthalate (PEN), polyethylene (PE), polypropylene (PP), polyetheretherketone (PEEK), polysulfone (PSF), poly(ether sulfones) (PES), polycarbonate (PC), polyamide (PA), polyimide (PI), methyl methacrylate resin, vinyl ester resin or triacetate cellulose (TAC).

In sum, the invention utilizes connecting the first and second metal wires 23, 43 to the X-axis and Y-axis sensing strings 21, 41 to reduce impedance in the transmission paths of the touch signals. As a result, not only can the quality of signal transmission of touch signals be improved, but also it is advantageous to design of large-sized touch panels. Also, thickness of the conductive film of the touch sensing layer can be reduced so that the material cost can be saved and transmittance of the touch sensing layer can be enhanced. In addition, the nanoscale first and second metal wires 23, 43 are substantially invisible and their occupation ratio to the whole area is below 0.3%. The light blocking rate is very low, almost all area of the touch sensing layer is light-permeable, so the transmittance is very great. Therefore, the tiny metal wires disposed in the sensing strings can effectively reduce impedance of the sensing strings and increase the efficiency of the signal transmission, but the visibility is not substantially affected.

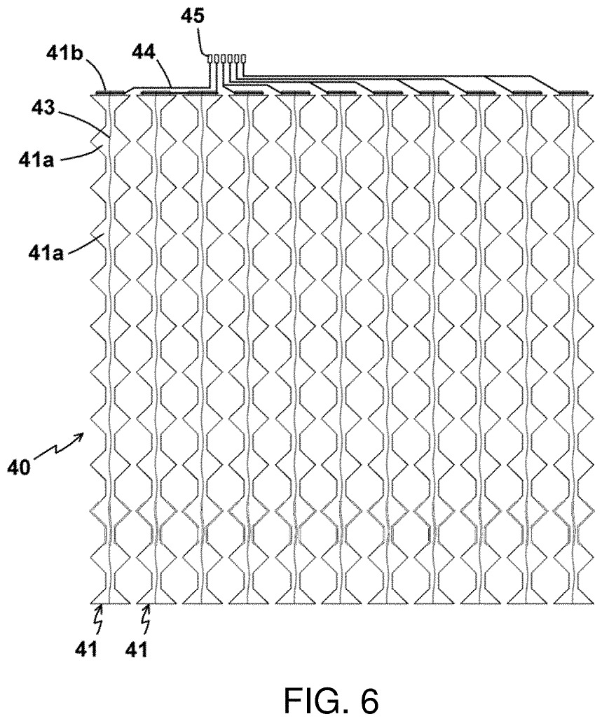

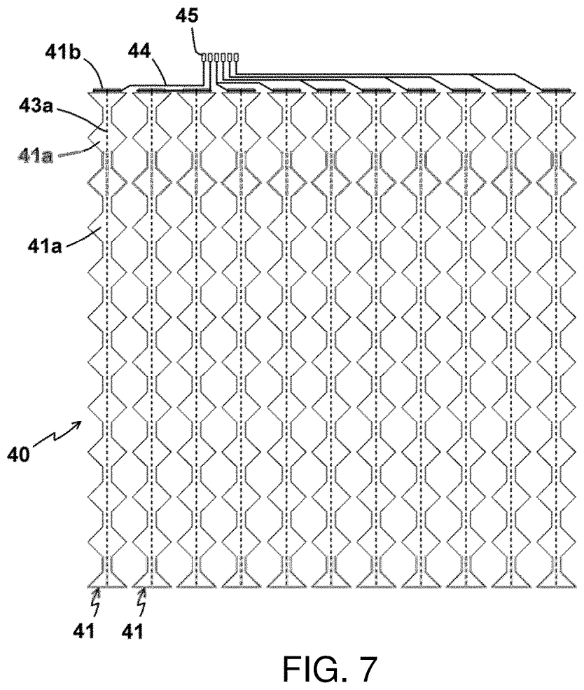

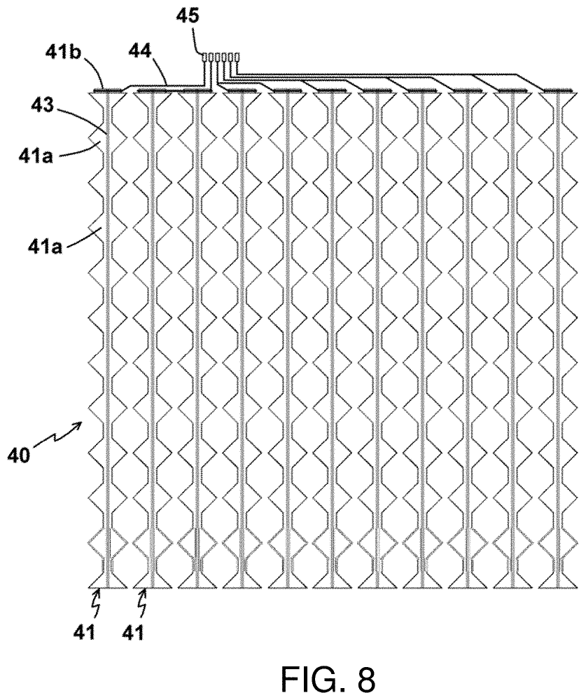

The metal wires 23, 43 shown in the above embodiment are continuous straight lines, but the transparent touch panel is attached outside the display, such straight metal wires may cause a moire pattern to affect image quality. Therefore, the conductive wires may be of a waved shape as shown in FIG. 6, metal mesh or other regular or irregular shapes to reduce optical interference. As shown in FIG. 7, the second metal wires 43a of the second sensing layer 40 are broken lines. As a result, impedance of such a broken wire 43a can be flexibly adjusted depending on actual requirements. Such a broken metal wire may also reduce optical interference and increase visibility. Also, other shapes may be available, for example, FIG. 8 depicts each set of second metal wires 43 composed of a plurality of lines parallelly arranged. This can guarantee high efficiency of signal transmission.

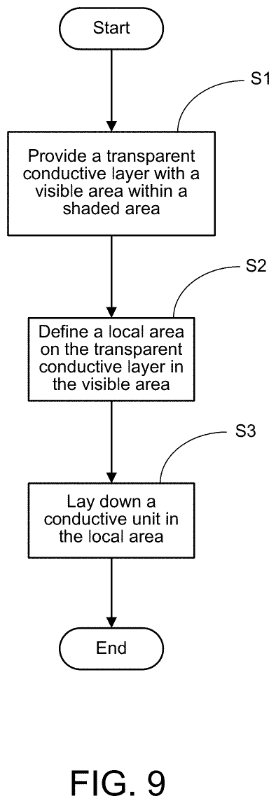

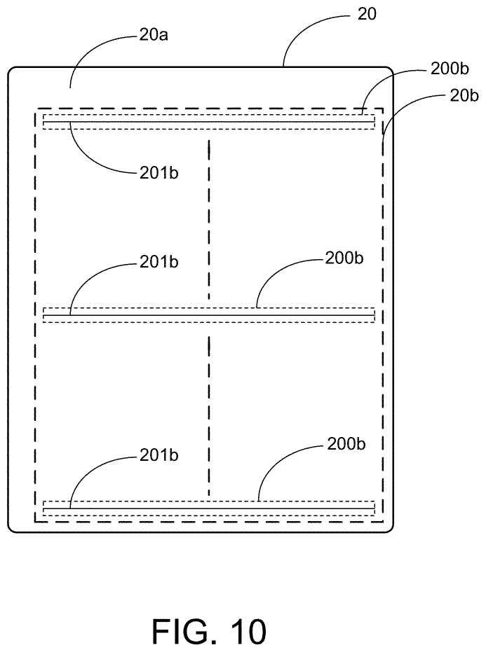

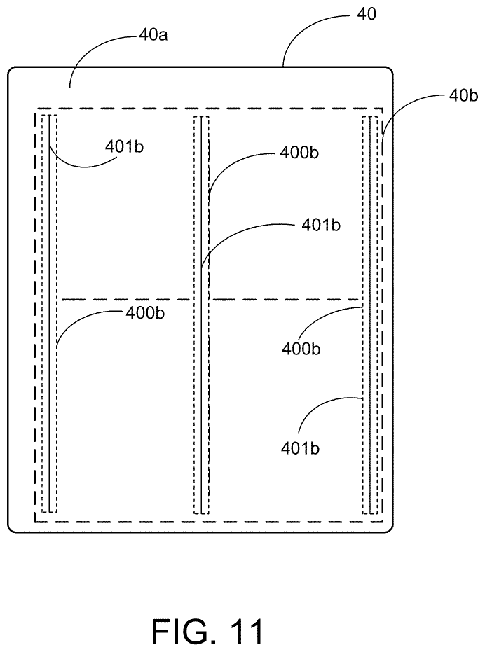

Please refer to FIGS. 9-11. FIG. 9 shows a flowchart of the method for reducing local impedance of a transparent conductive film according to the invention, and FIGS. 10 and 11 show two transparent conductive films made by the method abovementioned. In step S1, the method provides a transparent conductive layer which may be any one of the sensing layers 20, 40. As abovementioned, each sensing layer 20, 40 has a visible area 20b or 40b within a shaded area 20a or 40a respectively corresponding to and defined by the visible area 11b and the shaded area 11a of the base layer 10. In step S2, one or more local areas 200b or 400b are defined on the transparent conductive layer. In step S3, a conductive unit 201b or 401b is laid down in the local area 200b or 400b. The conductive unit is the metal wires 23, 43 as abovementioned. The transparent conductive layer is made of metal oxide or graphene. The metal oxide may be indium tin oxide, indium zinc oxide, aluminum zinc oxide, antimony tin oxide or poly(3,4-ethylenedioxythiophene). The local area includes touch sensing electrodes or touch signal transmission lines. The conductive unit 201b or 401b is metal wires or metal mesh. Electrical resistivity of each of the conductive elements 201b or 401b is below 8×10⁻⁸ Ω·m. The metal wires are made of gold, silver, copper, aluminum, molybdenum, nickel or an alloy thereof. A width of each of the metal wires is less than 25 μm, preferably less than 5 μm. Each of the metal wires is a continuously straight or waved line. Each of the metal wires is a broken line.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for reducing local impedance of a transparent conductive film, comprising:
a) providing a transparent conductive layer with a visible area within a shaded area;
b) defining a local area on the transparent conductive layer within the visible area; and
c) laying down a conductive unit in the local area.

2. The method of claim 1, wherein the transparent conductive layer is made of metal oxide or graphene.

3. The method of claim 1, wherein the metal oxide is indium tin oxide, indium zinc oxide, aluminum zinc oxide, antimony tin oxide or poly(3,4-ethylenedioxythiophene).

4. The method of claim 1, wherein the local area comprises touch sensing electrodes or touch signal transmission lines.

5. The method of claim 1, wherein electrical resistivity of the conductive elements is below 8×10⁻⁸ Ω·m.

6. The method of claim 5, wherein the conductive unit is metal wires or metal mesh.

7. The method of claim 6, wherein the metal wires are made of gold, silver, copper, aluminum, molybdenum, nickel or an alloy thereof.

8. The method of claim 6, wherein a width of each of the metal wires is less than 25 μm.

9. The method of claim 8, wherein the width is less than 5 μm.

10. The method of claim 6, wherein each of the metal wires is a continuously straight or waved line.

11. The method of claim 6, wherein each of the metal wires is a broken line.

12. A transparent conductive film, comprising:
a transparent conductive layer, having a visible area surrounded by a shaded area and a pre-determined local area in the visible area; and
a conductive unit laid down in the local area.

13. The transparent conductive film of claim 12, wherein the transparent conductive layer is made of metal oxide or graphene.

14. The transparent conductive film of claim 13, wherein the metal oxide is indium tin oxide, indium zinc oxide, aluminum zinc oxide, antimony tin oxide or poly(3,4-ethylenedioxythiophene).

15. The transparent conductive film of claim 12, wherein the local area comprises touch sensing electrodes or touch signal transmission lines.

16. The transparent conductive film of claim 12, wherein electrical resistivity of the conductive elements is below 8×10⁻⁸ Ω·m.

17. The transparent conductive film of claim 16, wherein the conductive unit is metal wires or metal mesh.

18. The transparent conductive film of claim 17, wherein the metal wires are made of gold, silver, copper, aluminum, molybdenum, nickel or an alloy thereof.

19. The transparent conductive film of claim 17, wherein a width of each of the metal wires is less than 25 μm.

20. The transparent conductive film of claim 19, wherein the width is less than 5 μm.

21. The transparent conductive film of claim 17, wherein each of the metal wires is a continuously straight or waved line.

22. The transparent conductive film of claim 17, wherein each of the metal wires is a broken line.
